(19) United States
(12) Patent Application Publication
(10) Pub. No.: US 2003/0154355 A1
(43) Pub. Date: Aug. 14, 2003

(54) Methods and apparatus for providing a memory challenge and response

(75) Inventor: Alberto J. Fernandez, Miami, FL (US)

Correspondence Address: PRIEST & GOLDSTEIN PLLC, 5015 SOUTHPARK DRIVE, SUITE 230, DURHAM, NC, 27713-7736, US

(73) Assignee: XTec, Incorporated, Miami, FL

(21) Appl. No.: 10/350,953

(22) Filed: Jan. 24, 2003

Related U.S. Application Data
(60) Provisional application No. 60/351,515, filed on Jan. 24, 2002.
(60) Provisional application No. 60/377,092, filed on May 2, 2002.

(51) Int. Cl. G06F 12/14

(52) U.S. Cl. 711/163; 711/164

(57) ABSTRACT

Techniques are described for providing a memory challenge and response to allow access to a protected memory area of a semiconductor memory or to authenticate the data written therein. These techniques may be combined with known cryptographic approaches. Further data stored in the protected areas may include mediametric values to further enhance security.

This application claims the benefit of U.S. Provisional Application Serial No. 60/351,515 filed Jan. 24, 2002 and U.S. Provisional Application Serial No. 60/377,092 filed May 02, 2002, which are incorporated by reference herein in its entirety.

### FIELD OF THE INVENTION

The present invention relates generally to improvements related to secure data storage and data authentication, and more particularly to advantageous methods and apparatus for providing memory challenge and response in such contexts.

### BACKGROUND OF THE INVENTION

Data stored in semiconductor memory cells may easily be read and written over, and also copied from one semiconductor memory device to another device designed to mimic the behavior of the token containing the semiconductor memory unless security features are implemented to restrict access to the memory cells and to authenticate the original data. Similarly, a counterfeiter may create a device that emulates the behavior of a valid device.

In some memory cell applications, such as integrated circuit cards or contactless cards that include semiconductor memory cells, it is essential to assure that the data stored in the memory remain secure as possible. This high level of security is especially important for applications where a local database is utilized having no central verification system. Another application concerns the use of cards containing such memory cells in network access, physical access control or on-line payment systems. The unauthorized modification of data stored in a chip card and the unauthorized copying of the data to another chip card for counterfeiting purposes, however, is not easily detectable using most commercially available technology. For example, the presently existing data security technique of providing holograms on chip cards may be compromised with relative ease and such chip cars with counterfeited holograms will have a low probability of detection.

In other applications, memory is segregated into different areas with one or more areas being protected with a first high level of security and one or more areas allowing more general access at a second different lower level of security. In such applications, it is essential to control access to the protected areas.

A need therefore, exists for improved techniques for securing data stored in memory cells of a semiconductor memory device and appropriately controlling access to any protected areas of the device.

Further, electronic value storage systems have gained widespread acceptance over the past thirty years or so, but the scope of applications in which they can be used continues to be limited. Such limitations may arise because the value storage system typically consists of a central database, with debits and credits being made at the database. A customer is typically issued a plastic card with a magnetic stripe identifying the customer's account. The card typically contains no balance information or other information besides the customer's account number or other identifying number. While challenge and response systems may exist for newer technologies, they do not work for a vast installed base of preexisting cards.

Legacy cards may contain no or very limited on card security provisions. Instead, security is provided by a separate access code or personal identification number (PIN) preferably memorized by the customer, which must be provided along with the card in order for the card to operate. The access code is preferably stored at the central database along with the identifying number found on the card.

The cards utilized in conjunction with the central database system are quite inexpensive, but the cost of the cards represents only a trivial portion of the cost of the overall system. The system is dependent on one or more central databases, each of which can be quite expensive. Moreover, the databases must be accessible to every terminal at which the card might be used. A typical system thus requires a card; a card reader at the point of sale; a central database at the customer's home bank; and a telecommunications network which must be able within seconds to establish a connection between a point-of-sale terminal in, for example, Los Angeles, and a central database in, for example, New York City.

The need for a large central database, which may need to be accessible over a wide area, increases the cost of the system and makes it impractical for a small merchant who may, for example, wish to institute an automated customer loyalty tracking and rewards program. For this and many other applications, it would be preferable to have value stored on the card itself. In this way, a distributed system of cards, readers, and databases could be created which was no larger than necessary to serve the required number of point-of-sale terminals. Unlike the case in which a central database was used, the distributed network would not require a central data storage location in order to operate. Moreover, under normal operation, one reader would not necessarily need to be in contact with another reader, but instead could execute its transactions independently.

Tokens, such as smart cards, are also well known in which information is stored directly on the card, but these systems suffer from several drawbacks. First, the cards and the readers are expensive. The cost of the card, in particular, is a significant factor, and limits the flexibility of practical uses of the card.

Smart cards also have their own security limitations. The danger therefore exists that fraudulently manufactured or emulated cards will be used, thus disrupting the business of legitimate customers.

A need therefore exists in the art for a low-cost, high-security system for electronic storage of value and identification data on an easily transportable medium such as a card with passive challenge and response authentication.

### SUMMARY OF THE INVENTION

The present invention provides methods and apparatus to perform challenge and response and mediametric authentication of data stored in tokens such as semiconductor memory devices, smart cards, contact cards, contactless cards, or the like, which may utilize various communication methods. For example, contact based smart cards that conform to the ISO7816 standard can be accommodated, as well as, contactless devices such as those utilizing the inductive coupling methods defined in the ISO14443 or IS15693 standards. Tokens include passive devices, devices that do not contain microprocessors. A contactless card is card whose information is communicated to a card reader without the card physically contacting the reader. A contactless card usually communicates with the card reader using commonly known radio frequency communication methods.

In one aspect, the present invention provides methods and apparatus for a challenge and response protected memory with optional mediametric authentication. As discussed in greater detail below, a memory device, such as a semiconductor integrated circuit or other token, is defined so that a number of predefined memory areas are used to control access to protected areas of the device.

According to another aspect, authentication of passive stored data is achieved with an advantageous challenge and response approach. Again, an optional mediametric authentication or other cryptographic relationships may be suitably employed to provide additional system security.

According to another aspect, authentication of passive stored data is achieved by adding a cryptographic primitive within the memory device. This aspect provides the memory device additional security by precluding a spying device from monitoring memory writes and then utilizing those writes in a subsequent authentication process.

These and other advantages and aspects of the present invention will be apparent from the drawings and the Detailed Description which follow below.

### BRIEF DESCRIPTION OF THE DRAWINGS

FIG. 1 shows an exemplary value storage system with which the present invention may be suitably employed to add challenge and response authentication;

FIG. 2 shows an exemplary arrangement for accessing data stored on an EEPROM which has been adapted in accordance with the teachings of the present invention to add challenge and response control of access to protected areas of memory;

FIG. 3 shows a table illustrating initial accesses, accesses after correct response, and memory definitions in accordance with a first embodiment of the present invention; and

FIG. 4 shows a table illustrating initial accesses, accesses after correct response, and memory definitions in accordance with a second embodiment of the present invention.

FIG. 5 shows a table illustrating initial accesses, accesses after correct response, and memory definitions in accordance with a third embodiment of the present invention.

FIG. 6 shows a flow chart of an exemplary method in accordance with the first embodiment shown in FIG. 3.

FIG. 7 shows a flow chart of an exemplary method in accordance with the first embodiment shown in FIG. 4.

FIG. 8 shows a flow chart of an exemplary method in accordance with the first embodiment shown in FIG. 5.

### DETAILED DESCRIPTION

The present invention addresses improved techniques for providing memory challenge and response authentication which may be advantageously employed in conjunction with systems employing one or more aspects of the following applications and patents: U.S. patent application Ser. No. 07/655,546 filed Feb. 14, 1991, now U.S. Pat. No. 5,235,166, issued Aug. 10, 1993; U.S. patent application Ser. No. 08/100,120, filed Jul. 30, 1993, now U.S. Pat. No. 5,430,279, issued Jul. 4, 1995; U.S. patent application Ser. No. 08/420,745, filed Apr. 12, 1995, now U.S. Pat. No. 5,616,904, issued Jan. 1, 1997; U.S. patent application Ser. No. 08/367,084, filed Dec. 30, 1994, now U.S. Pat. No. 5,644,636, issued Jul. 1, 1997; U.S. patent application Ser. No. 08/963,181, filed Nov. 3, 1997, now U.S. Pat. No. 6,266,647, issued Jul. 24, 2001; U S. patent application Ser. No. 09/562,336, filed May 1, 2000; U.S. patent application Ser. No. 09/563,448, filed May 1, 2000; U.S. patent application Ser. No. 09/562,989, filed May 1, 2000; U.S. patent application Ser. No. 09/562,365, filed May 1, 2000; U.S. patent application Ser. No. 09/562,333, filed May 1, 2000; U.S. patent application Ser. No. 09/844,105, filed Apr. 27, 2001, all of which are assigned to the assignee of the present invention and incorporated by reference herein in their entirety.

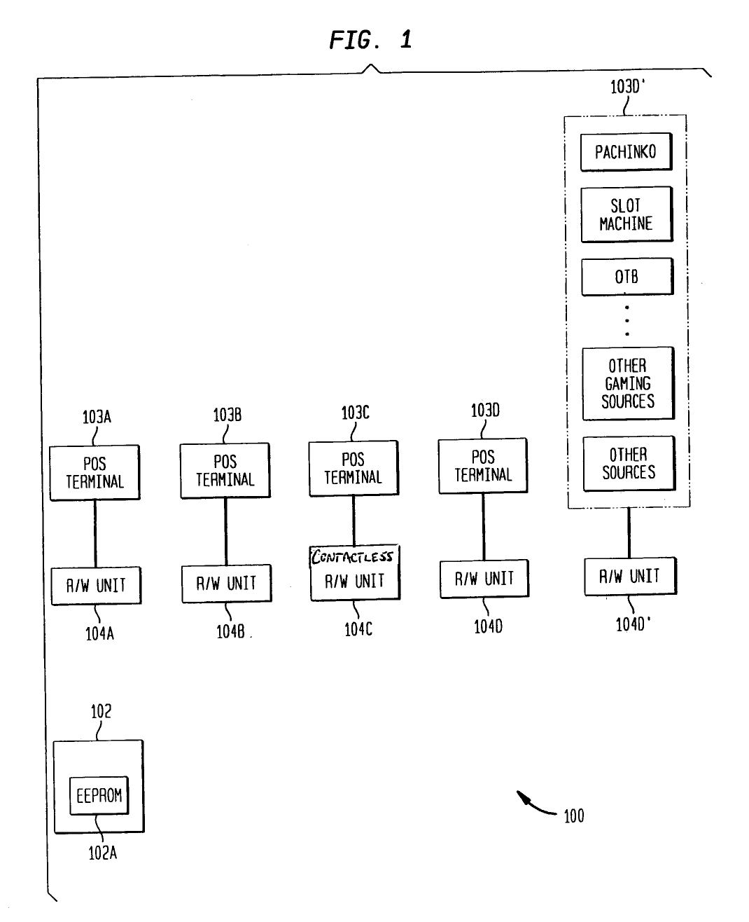

FIG. 1 shows a value storage system 100 which may be suitably adapted to employ the principles of the present invention. System 100 is suitably adapted to the administration of a consumer or customer loyalty program operated by a merchant with a plurality of branches in a particular geographic area. System 100 includes a plurality of cards, of which an illustrative example is card 102, which are used as an easily transportable medium for the storage of data or information, such as value indicia, customer identification, customer profile information, bonus points based upon the dollars spent by the customer, points, gaming winnings, or the like. Card 102 preferably contains an EEPROM 102A for the storage of data, suitable for use with a data security system according to the teachings of U.S. Pat. No. 5,644,636, which is incorporated herein by reference. The use of the data security system in conjunction with the teachings of the present invention protects against counterfeiting and provides for a high level of confidence in the integrity of the data without the need for complicated and expensive communication systems to verify each individual transaction. By segregating the memory of one of more EEPROMs 102A and controlling access to protected areas therein as taught herein, an advantageous challenge and response system can be added in a cost effective manner to control access to protected areas of memory.

System 100 may further include card read/write units 104A-D, each of which is adapted to operate with any of the cards in the system including contact cards, contactless cards, and the like. Unit 104C illustrates an exemplary contactless read/write unit. The units 104A-D way be located in a single store or distributed through a number of stores. Although four units are shown, it will be recognized that a smaller or typically, a larger number of units may be readily employed as desired. The advantages provided by the present invention will be readily adaptable to a host of applications.

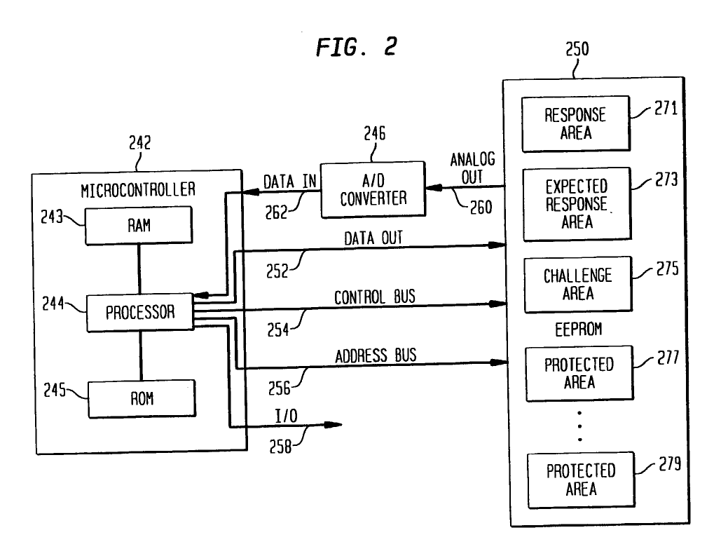

FIG. 2 illustrates an exemplary arrangement for writing data to an EEPROM 250 which may be utilized as the EEPROM 102A of FIG. 1 by use of a standard microcontroller 242. Data may be read out to the microcontroller through a standard analog-to-digital converter (ADC) 246. In one embodiment, the EEPROM 250 is included in a single semiconductor device or an integrated circuit (IC) in order to secure data in a cost efficient manner according to the techniques of the present invention. For example, the present invention may be implemented by using memory cells fabricated on a standard ISD 1000A Integrated Circuit, however, most semiconductor memory devices could be adapted for use with this invention.

Typically, it would be desirable for the microcontroller 242 and the ADC 246 to be included in a device separate from the EEPROM 250, such as, for example, in a bank card machine or an automated teller machine. The EEPROM 250 then would be located on, for example, a chip card. Alternatively, the microcontroller 242 and/or the ADC 246 may be included with the EEPROM 250 in a single semiconductor device. For purposes of illustration, the components in FIG. 2 are described in terms of the EEPROM 250 being implemented on a standard integrated circuit.

Referring to FIG. 2, the microcontroller 242 suitably comprises a processor 244, such as a standard microprocessor, connected to a ROM 245 and a RAM 243, all on an integrated circuit. Alternatively, the processor 244, RAM 243 and ROM 245 may be discrete devices. A data out line 252, a control bus 254 and an address bus 256 are all connected from the processor 244 to the EEPROM 250 according to conventional techniques. The microprocessor 244 also comprises an input/output (I/O) port 258 which may comprise any standard interface, including but not limited to, the RS-232, I2C or the ISO/IEC 781 S3 standard chip card interface. The I/O bus port 258 is any standard interface that may be used for interconnecting the microcontroller 242 to an external device, such as a bank machine card reader or an asynchronous card swipe reader. The control bus 254 typically may comprise signal lines such as chip enable, read/write select, and output enable. An analog out line 260 from the EEPROM 250 is connected to an analog input port of the ADC 246, and a data in line 262 connects a digital output port of the ADC 246 to the processor 244.

Power supplies, signal grounds, and signal conditioning components which would ordinarily be included in the design of the EEPROM 250, the microcontroller 242 and the ADC 246 according to conventional design practices are not shown in FIG. 2 for ease of illustration, but of course would be in a known manner.

The microprocessor 244 of the microcontroller 242 transmits control signals on the lines of the control bus 254 for controlling the performance of read and write operations with respect to the EEPROM 250. The processor 244 transmits appropriate data on the address bus 256 to select the particular memory cells or memory arrays in the EEPROM 250 where a bit or group of bits are to be read or written. The processor 244 writes data to the EEPROM 250 by applying a voltage signal on the data out line 252 whose magnitude is related to the logic level of the data bit to be written. Typically, the voltage signal levels which a microprocessor may provide on a data out line for writing a representation of the data bits “0” and “1” to a memory cell are equal to 0.5 Volts +/−10% and 4.5 Volts +/−10%, respectively.

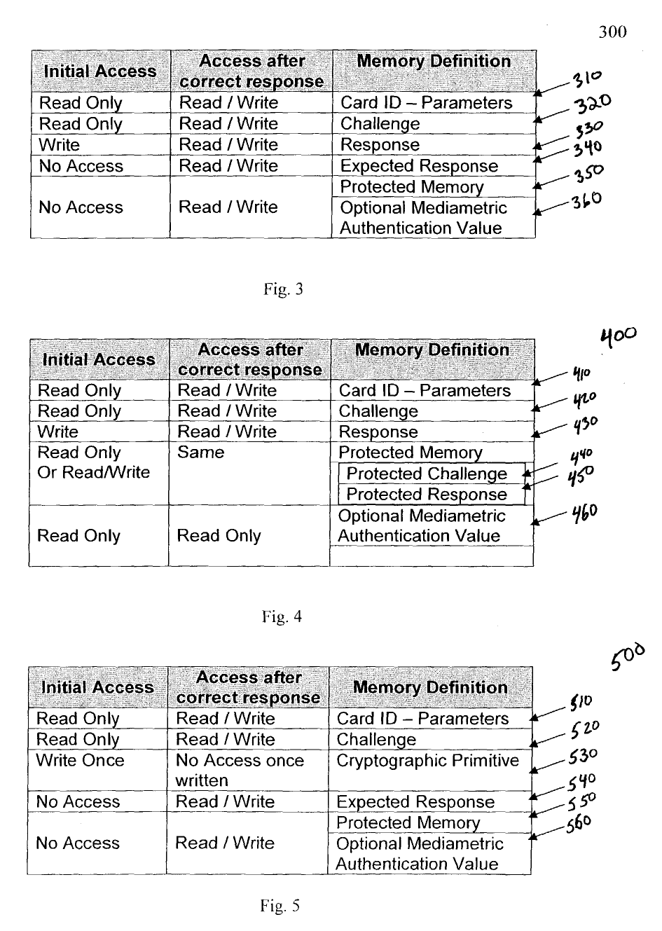

In accordance with the present invention, areas of the memory of EEPROM 250 are petitioned into areas which are protected with one level of security, and areas with another lower level of security. As addressed below, challenge and response capability may be advantageously added as taught in FIGS. 3, 4, and 5.

One embodiment of the present invention addresses a memory device, typically a semiconductor integrated circuit, possessing a number of predefined memory areas used to control access to protected areas of the device. The memory device can also be optionally equipped with an analog interface to allow the measurement of the individual cell charges to perform a mediametric authentication. For further details of a presently preferred mediametric authentication, see U.S. Pat. No. 5,644,636 which is incorporated by reference herein in its entirety.

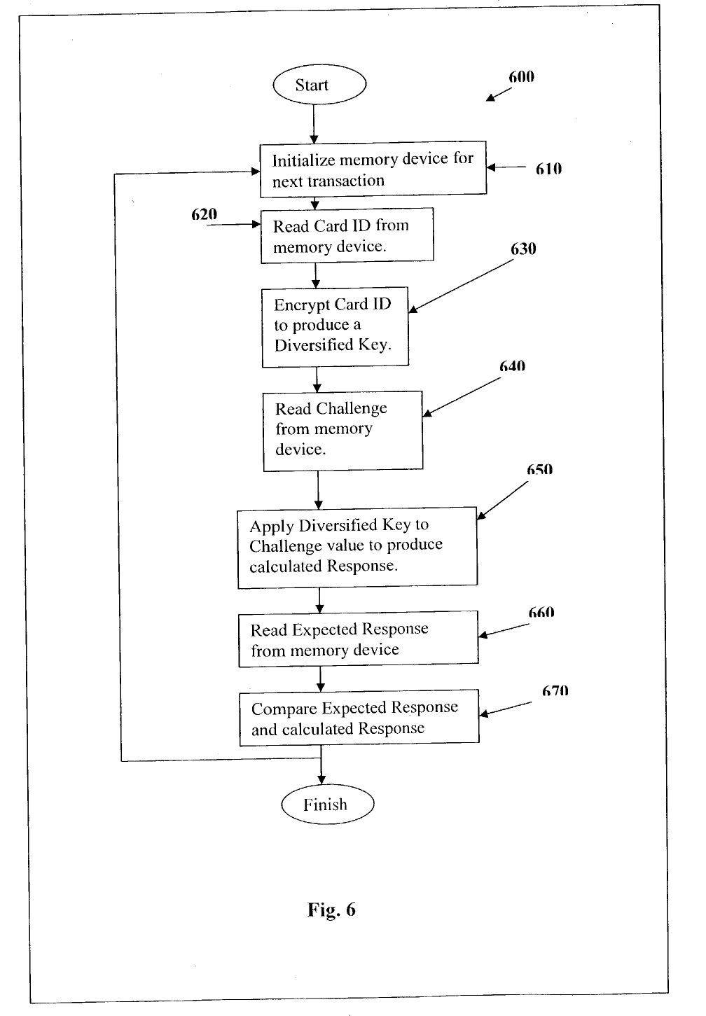

As illustrated in table 300 of FIG. 3, a protected memory area or areas 277 . . . 279 are accessible as indicated above when a value is stored in a Response area 271 that matches the contents of an Expected Response area 273. For reasons which will be understood in conjunction with the discussion of the flowchart in FIG. 6, it is noted that the Response is only optionally stored on the memory device. A Challenge area 275 contains a value that is used to generate the proper Response. Typically, there is a cryptographic relationship between the two. The protected area or areas 277 . . . 279 can also contain a mediametric authentication value.

A second embodiment of the present invention illustrated in table 400 of FIG. 4 addresses authentication of data stored in a memory device, typically a semiconductor integrated circuit, possessing a number of predefined memory areas by performing a cryptographic challenge/response test. In this embodiment, an additional cryptographic challenge/response test is performed using additional challenge/response values stored within protected memory. The challenge/response values will initially have at least read access.

The Challenge consists of data stored in an area of memory, which contains certain expected values such as a date code and/or sequence code, or any other suitable expected value.

The Response is cryptographically related to the Challenge, and optionally the other payload data stored in the device, by a secret key in such a manner that the presence of valid Response data indicates that the originator has possession of the secret key and therefore authenticates all of the data.

This Challenge and corresponding Response may be updated with a new Challenge and valid Response after each successful authentication.

A third embodiment of the present invention illustrated in table 500 of FIG. 5 addresses authentication of data stored in a memory device, typically a semiconductor integrated circuit, possessing a number of predefined memory areas by performing the same challenge/response as in either of the first two embodiments with an additional cryptographic primitive stored on the memory device. The cryptographic primitive enables a transformation of the Response data when a card read/write unit such as 104A writes the Response into memory. The cryptographic primitive is electrically or magnetically connected to the Response location in memory such that when the card read/write unit attempts to write to the Response location, the connection within the card transforms the value by considering the contents within the cryptographic primitive. The cryptographic primitive is stored in a write once field and is inaccessible by a card read/write unit. The cryptographic primitive may include operations such as exclusive OR, bit shifting, or the like, in order to perform the transformation.

FIGS. 6-8 illustrate exemplary flowcharts for each of the three embodiments of the present invention. The steps disclosed in these exemplary flowcharts may be performed in any order unless specifically stated otherwise.

FIG. 6 illustrates an exemplary flowchart 600 according to the embodiment of the present invention of FIG. 3. At step 610, before a memory device such as a card is presented to a card reader 104A, the memory fields such as the Challenge and the Expected Response on the card are initialized. The Challenge 320 and the Expected Response 340 are cryptographically related. Step 620 is entered when the card is presented to begin a commercial transaction. The card reader will read the Card ID 310 from the memory device. The Card ID 310 will typically contain some unique identifier that distinguishes this card from any other card used for the intended purpose for which the card is presented. At step 630, the card reader applies a standard encryption algorithm to the Card ID 310 itself or the unique identifier within the Card ID 310 to produce a unique Diversified Key. At step 640, the card reader reads the Challenge value from the card. At step 650, the card reader applies the Diversified Key to the Challenge value to produce a calculated Response. Depending on the desired function of a card application, the calculated Response may be optionally stored on the memory device in the Response 330 field. When the Response is not stored on the memory device, the reader authenticates the card. When the Response is stored on the memory device, both the reader and card are authenticated. In either case, access to protected memory is controlled. At step 660, the card reader reads the Expected Response 340 memory location. At step 670, the card reader compares the Expected Response with the calculated Response to determine whether the card is authentic. It is noted that steps 660 and 670 might alternatively be performed on the card if the desired card application requires that the card reader be authenticated. In this case, as the Response 330 field is written, the card compares the Response 330 with the Expected Response 340 values.

If the Responses are equal, the subsequent transaction may proceed and that transaction may access the protected areas within the card's memory as need. Access to the protected areas is controlled by commonly known latched circuitry within the card. With access to the protected memory area, the mediametric profile 360 may then be read and compared with measured mediametric characteristics to further authenticate the card. Locations in protected memory may also be used for securely storing accumulated loyalty points, personal transaction history, medical records, and the like. Additionally, to preclude counterfeiters from copying the memory locations of an authentic card into a counterfeit card and replaying that card or to preclude use of a lost or stolen card, a new Challenge and Expected Response may be set by the reader device by proceeding to step 610.

It is noted that if the POS terminals 103A-D are connected to a central database via a communications network, the system can immediately recognize whether a fraudulent transaction has occurred rather than having to wait for the monthly bill to arrive at the rightful card owner. Typically, a sequence number derived from each unique card would be stored in the central database and compared to one which is encrypted as part of the Challenge.

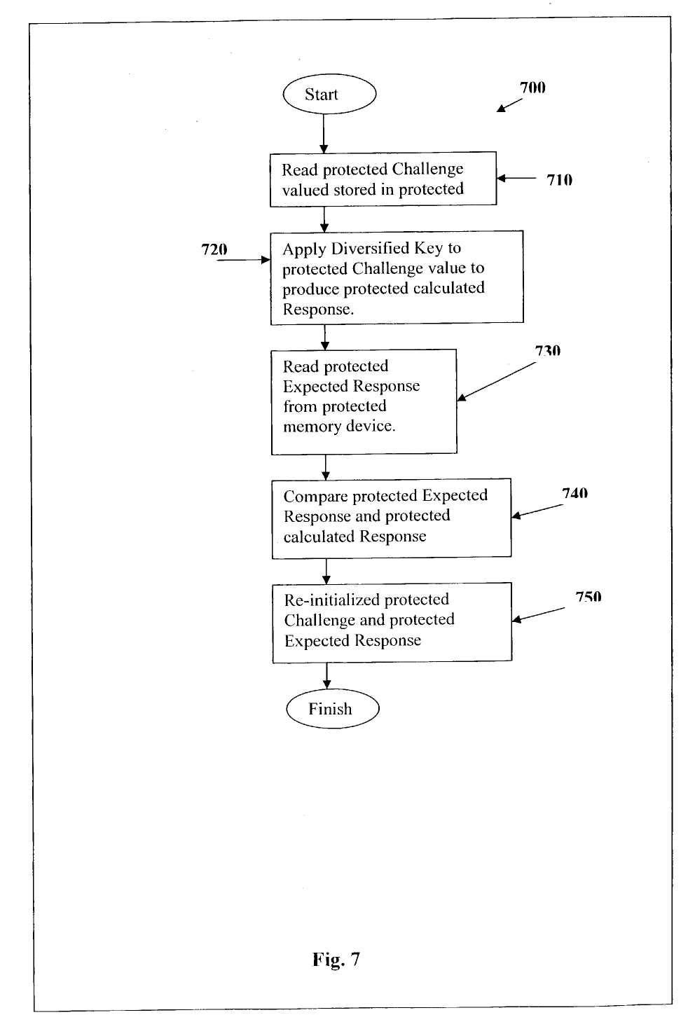

FIG. 7 illustrates an exemplary flowchart 700 according to the embodiment of the present invention of FIG. 4. A subsequent level of security within the protected memory is provided to preclude a counterfeiter from developing his own card reader device and attempting to fool the card into thinking that there was a match between the calculated Response and the Expected Response. Flow chart 700 assumes that a method such as exemplary method 600 has previously occurred such that the card reader now has access only to the portion of protected memory containing the protected Challenge 440 and protected Expected Response 450. At step 710, the card reader reads the protected Challenge 440. This embodiment provides multiple levels of security because only authorized card readers would know that cooperation with a Challenge/Response method within protected memory is necessary in order to gain access to other protected memory locations. At step 720, the card reader applies the Diversified Key to the protected Challenge value to produce a protected calculated Response. At step 730, the card reader reads the Expected Response from protected memory. At step 740, the card reader compares the protected Expected Response and the protected calculated Response. If the comparison is equal, access is provided to the other areas of protected memory. At step 750, the card reader reinitializes the protected Challenge and protected Expected Response for a subsequent transaction.

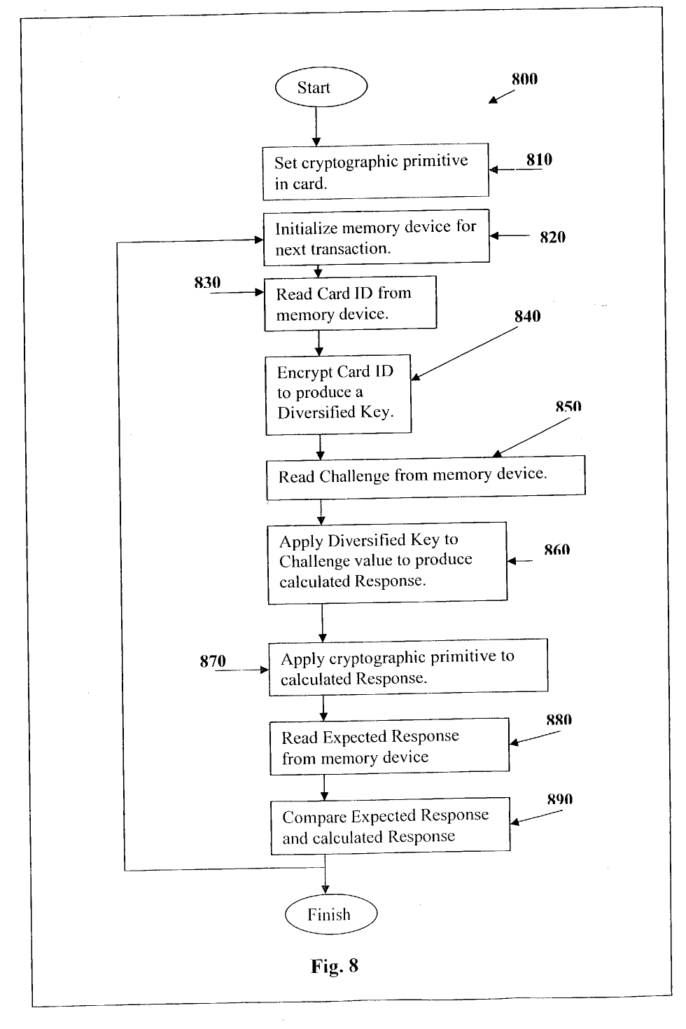

FIG. 8 illustrates an exemplary flowchart of a process 800 according to the embodiment of FIG. 5. At step 810, the manufacturer of the card will set the cryptographic primitive 530 and electrically or magnetically connect it to Expected Response 540 location in memory. The cryptographic primitive is stored in a write once field with no further access by an external device. At step 820, the Challenge is initialized and the Expected Response is calculated by applying a typical encryption algorithm. When the Expected Response is written to the card, the Expected Response field stores a value that has been transformed by the cryptographic primitive. Steps 830, 840, 850, and 860 correspond to similar steps 620, 630, 640, and 650, respectively. At step 870, the card reader applies the cryptographic primitive to the calculated Response to produce a transformed calculated Response. At step 880, the card reader reads the transformed Expected Response from the card. At step 890, the card reader compares the transformed Expected Response with the transformed calculated Response to gain access to the protected memory on the card. It is noted that steps 870, 880, and 890 might alternatively be performed on the card in a similar manner as described in the disclosure of FIG. 6. If the Responses are equal, access to protected memory will be granted and the subsequent transaction may begin. With access to the protected memory area, the mediametric profile 560 may then be read and compared with measured mediametric characteristics to further authenticate the card. Additionally, the Challenge and Expected Response may be reset for when the card is subsequently presented for a different transaction by proceeding to step 820.

Contactless or inductively coupled devices can also be mediametrically authenticed by measuring the dynamic characteristics of the electromagnetic field being used for its inductive interface. Each device or family of devices exhibit certain field amplitudes, rate of signal amplitude changes, and timing characteristics of the communication signals that are unique to the device or family of devices and which can then be compared to a previously captured profile of the device, or family of devices, for the purpose of authenticating the device. Since these characteristics are dependent on the specific construction, fabrication and even defects in the device, they are extremely difficult to reproduce or emulate and provide a high level of security. Refer to U.S. Pat. No. 5,616,904 for further details of methods and apparatus for mediametrics based on magnetic bit transitions and U.S. Pat. No. 5,644,636 for methods and apparatus for mediametrics based on stored charges in memory cells.

The storage device can also be optionally equipped with an analog interface to allow the measurement of the individual cell charges to perform a mediametric authentication as described in U.S. Pat. No. 5,644,636.

While the present invention has been disclosed in a presently preferred context, it will be recognized that the present invention may be variously embodied consistent with the disclosure and the claims which follow below.

I claim:

1. A method for providing a memory challenge and response capacity to a semiconductor memory comprising the steps of:
storing an expected response value in an expected response area of memory; and
storing a challenge value in a challenge area of memory, said challenge value being used to generate the proper response used to allow access to a protected area of the semiconductor memory.

2. The method of claim 1 wherein there is a cryptographic relationship between the challenge value and the proper response.

3. The method of claim 1 wherein the protected area stores a mediametric authentication value.

4. The method of claim 1 further comprising the step of:
Storing a response value in a response area of memory, said response value calculated by a card reader applying cryptography to the challenge value.

5. The method of claim 1
wherein the expected response area in memory is connected to a cryptographic primitive,
wherein the storing expected response value step further comprises the step of transforming the expected response value by the cryptographic primitive.

6. An apparatus for providing a memory challenge and response capacity to a semiconductor memory comprising:
means for storing an expected value in an expected response area of memory; and
means for storing a challenge value in a challenge area of memory, said challenge value being used to generate the proper response used to allow access to a protected area of the semiconductor memory.

7. The apparatus of claim 6 wherein there is a cryptographic relationship between the challenge value and the proper response.

8. The apparatus of claim 6 wherein the protected area stores a mediametric authentication value.

9. The apparatus of claim 6 further comprising:
means for storing a response value in a response area of memory;

10. The apparatus of claim 6 further comprising:
means for storing a cryptographic primitive, the cryptographic primitive connecting to the expected response area of memory and transforming the expected response value when writing to the expected response area.

11. A method of authenticating data in a memory device comprising the steps of:
performing a challenge comprising data stored in an area of memory containing expected values; and
utilizing a response cryptographically related to the challenge.

12. The method of claim 11 comprising the step of:
storing payload data related to the challenge by a secret key whereby the presence of valid response data indicates that the originator has possession of the secret key.

13. The method of claim 11 further comprising the step of:
updating the response and challenge after each successful authentication.

14. A method of performing mediametric authentication of contactless devices such as inductively coupled devices comprising the steps of:
measuring the signal amplitudes, rates of change, and timing characteristics as well as other device and/or class of device specific parameters to create a profile of the device being evaluated; and
comparing the resulting profile to the previously known and trusted profile of the device or class of devices to determine authenticity.

15. A method of performing mediametric authentication of contactless devices such as inductively coupled devices comprising the steps of:
measuring communication characteristics of a contactless device, said characteristics uniquely identify the contactless device;
creating a profile from the measured characteristics;
storing the profile of the characteristics on the contactless device;
when presenting the contactless device for a transaction, reading the profile from the contactless device;
measuring the communication characteristics of the contactless device; and
comparing the read profile with the communication characteristics.

16. A method of claim 15 wherein the communication characteristics is a signal amplitude of a communication signal from the device, a rate of signal amplitude changes, or timing characteristics of communicating data.
